(19) United States
(12) Patent Application Publication
(10) Pub. No.: US 2010/0102100 A1
(43) Pub. Date: Apr. 29, 2010

(54) SHOPPING BAG

(76) Inventors: Joseph F. Hickey, Basking Ridge, NJ (US); Paul Auger, Bath, PA (US); Edward Hogrelius, Mountainside, NJ (US); James Waters, Kearny, NJ (US); Timothy H. Shinn, Manasquan, NJ (US); Maria Dionyssiou, Jersey City, NJ (US)

Correspondence Address: NORRIS MCLAUGHLIN & MARCUS, P.A., 721 ROUTE 202-206, P.O.BOX 5933, BRIDGEWATER, NJ, 08807-5933, US

(21) Appl. No.: 12/541,433

(22) Filed: Aug. 14, 2009

Related U.S. Application Data
(63) Continuation-in-part of application No. 12/354,014, filed on Jan. 15, 2009.
Application No. 12/354,014 is a continuation-in-part of application No. 12/256,765, filed on Oct. 23, 2008.

(51) Int. Cl. B60R 9/00

(52) U.S. Cl. 224/411

(57) ABSTRACT

In one aspect, a shopping bag or carryall (hereinafter, shopping bag and carryall refer to the inventive shopping bag interchangeably unless otherwise noted) is describe that addresses the problems and inconvenience of having to carry multiple articles and personal items individually into a store, and access those articles in the store when shopping. The shopping bag assists the shopper by organizing the many necessities typically carried and used by shoppers. The numerous features of the bag serve to protect and makes immediately available all of the typical items a shopper may need.

### CROSS REFERENCE TO RELATED APPLICATION

This application is a Continuation-in-Part of U.S. patent application Ser. No. 12/354,014 filed Jan. 15, 2009, which is a Continuation-in-Part of U.S. patent application Ser. No. 12/256,765, filed Oct. 23, 2008, the entirety of which is hereby incorporated by reference into this application.

### BACKGROUND OF THE INVENTION

1. Field of the Invention

The invention relates to shopping bags or carryalls. More particularly the invention relates to shopping bags that organize and assist shoppers with carrying their items and necessities.

2. Description of the Related Art

In the current environment, the typical shopper faces a number of problems or difficulties associated with carrying and organizing their personal items, as well as carrying and transporting their purchases. Various attempts have been made to address certain specific problems or difficulties but no one bag or device is available that considers all or even most of these problems in one device.

Many shoppers have numerous items that must be carried in addition to the items being purchased. For example, the typical shopper may have a bulky handbag for personal items. Many stores now require or encourage patrons to use reusable bags that the shopper brings into the store. The shopper may have a cell phone, a grocery list, a water bottle. Shoppers with babies or small children may have a baby bottle. If there is inclement weather the shopper may have an umbrella. The typical shopper may have an unwieldy amount of items that are routinely carried in today's environment.

Another problem facing the shopper is where to keep the handbag or purse while shopping. As these can be heavy, it is not always practical to keep them over the shoulder or over the arm. Keeping the bags Inside the shopping cart can crush the contents of the bag or stain the hand bag with food and other products. This is especially problematic if there is a child in the child seat of the cart. Finally keeping the hand bag in the cart may be inconvenient for easy access to the contents of the bag.

It would be desirable to have a device that stores all of the shoppers' personal items, reusable bags, and shopping accessories in one convenient carryall. It would be desirable to have a device that is designed to hang freely on the outside of the shopping cart, in a position that is out of the way of the contents of the shopping cart, yet conveniently in reach to retrieve items instantly. It would be desirable to a have a device that in addition to storing all of the shoppers' personal items, is designed to make it easier and simpler to transporting full shopping bags.

### SUMMARY OF THE INVENTION

In one aspect, a shopping bag or carryall (hereinafter, shopping bag and carryall refer to the inventive shopping bag interchangeably unless otherwise noted) is describe that addresses the problems and inconvenience of having to carry multiple articles and personal items individually into a store, and access those articles in the store when shopping. The shopping bag assists the shopper by organizing the many necessities typically carried and used by shoppers. The numerous features of the bag serve to protect and makes immediately available all of the typical items a shopper may need.

In another aspect, the shopping bag provides a simplified and safe way to transport the purchased products out of the store and out of a vehicle. In particular, the shopping bag is designed so that multiple grocery bags (or other purchases or bagged items) can be linked together and conveniently be carried with one hand.

The shopping bag or carryall performs these functions by incorporated one or more of a number of different features into the bag. The shopping bag may have such features as devices, flaps, pockets, straps, and wraps that are attached to a bag to make shopping easier, safer, and more efficient.

In one embodiment, the shopping bag has a main component that holds and transports re-useable, for example canvas, shopping bags. This shopping bag has a strap or straps that easily attaches and de-attaches to the handle of a shopping cart in such a way that the shopping bag hangs below the handle and outside of the interior of the cart. In this way, the bag does not interfere with the shoppers' normal shopping activities, such as pushing the cart or loading the cart with items, yet the bag and its contents are easily accessible.

In another embodiment, the shopping bag has a clear plastic pocket that rotates or flips up from the interior of the bag to rest on the shopping cart handle. The clear plastic and an angle at which it rests on the handle allows the shopper to see or read any items within the plastic pocket. For example, the pocket may hold a grocery list or coupons. In a preferred embodiment, the pocket removably encloses a white board. The white board can have magnetic backing so that it attaches to a metal appliance such as a refrigerator. This configuration allows the shopper to continually add items to the list while at the home and simply enclose the list in the shopping bag.

In another embodiment, the shopping bag stores one or more shopping cart handle wraps that can be placed around the handle of the shopping cart. The shopping cart handle wraps cover the handle primarily for sanitary reasons, or simply for comfort. The wraps are placed around the outer surface of the handle of the cart and secured by a variety of means. A separate compartment in the shopping bag stores the wraps before and after use and is preferably located on the outside of the bag. The wraps can be made out of any number of materials but are preferably constructed out of a cloth material that is washing machine safe.

In another embodiment, the inside the bag has one or more of the following pockets: a pocket specifically sized for storing a collapsible umbrella; one or more compartments for water or baby bottles. The pockets are preferably positioned on the side walls in a vertical position to avoid spilling the contents of the bottles on the inside the bag.

In another embodiment, this shopping bag has a large front outer pocket intended to carry and store personal items and necessities typically carried in a hand bag. This outer pocket may have one or more separate pockets to secure and make readily available certain items. These separate pockets can be sized for specific items such as for example, a cell phone. The outer pocket may also have one or more smaller pockets attached to the outside of the outer pocket. These pockets may be used to store shopping items such as coupons, notes etc.

The shopping bag or carryall also assists the shopper to better carry the full grocery bags after shopping is completed. The term grocery bag is used to mean any bag containing additional items obtained while shopping but is not necessarily limited to groceries. In most instances, the full grocery bags must be transported somewhere after being purchased without the aid of the shopping cart, i.e. either to a car or home, or likely from the store to the car and then from the car into the home. These heavy grocery bags can be inconveniently and somewhat painfully carried in between their fingers or can be carried separately in multiple trips.

To address this problem the shopping bag or carryall preferably includes handles or adjustable bands permanently attached to the main body of the bag, which allows the shopper to easily attach additional full grocery bags. Additionally, a shoulder strap is provided for the opposite shoulder to group carry additional bags together making transporting the bags easier and safer.

In an alternate embodiment, one or more shoulder straps are permanently attached to the side or detachably secured to the top of the main body of the bag so the shopper can carry the shopping bag and grocery bag hands free. One shoulder strap can be attached to the additional shopping bags being carried on the opposite shoulder. The inventive shopping bag alleviates the pain and discomfort from carrying of heavy grocery bags between the fingers possibly resulting in injury and minimizing the trips from the car into the home.

In another alternate embodiment, the shopping bag contains two or more multifunctional adjustable length bands that can be secured to the bag in a number of different configurations. The bands can be attached to form loops for securing additional bags to the bag. The bands can be secured on either end so that the bands extend across the opening of the bag to form shopping cart handles. Finally, the bands can be secured to extend down the face of the bag to operate as backpack or over the shoulder straps.

### BRIEF DESCRIPTION OF THE DRAWINGS

The drawings are intended to be illustrative, are not drawn to scale and are not intended to limit the scope of the claims to the embodiments depicted.

FIGS. 1 and 2 are perspective views of one embodiment of the shopping bag of the invention.

FIG. 3 is a top view of one embodiment of the shopping bag of the invention.

FIG. 4 is a side view of the shopping bag of the invention attached to a shopping cart.

FIG. 5 is a rear view of the shopping bag of the invention attached to a shopping cart.

FIG. 6 is a shopping cart handle wrap included in one embodiment of the shopping bag.

FIG. 7 is a set of handle grips included in one embodiment of the shopping bag.

FIG. 8 is a reusable grocery bag included in one embodiment of the shopping bag.

FIG. 9 is a hot and cold bag included in one embodiment of the shopping bag.

FIG. 10 is a shoulder strap included in one embodiment of the shopping bag.

FIG. 11 is a perspective view of an alternate embodiment of the shopping bag of the invention.

FIGS. 12 and 13 is a perspective view of the front and back of an alternated embodiment of the shopping bag of the invention.

FIG. 14 is an additional bottom compartment to the shopping bag.

FIG. 15 is an interior view of a shopping bag of the invention showing additional optional features.

### DESCRIPTION OF THE PREFERRED EMBODIMENTS

The present invention is described in detail using preferred embodiments. The present invention, however, is not limited to these embodiments. Additionally, a requirement in an embodiment is freely applicable to other embodiments, and requirements are mutually replaceable unless special conditions are attached. In one embodiment a kit is provided including the shopping bag and one or more accessories that work as an assembly.

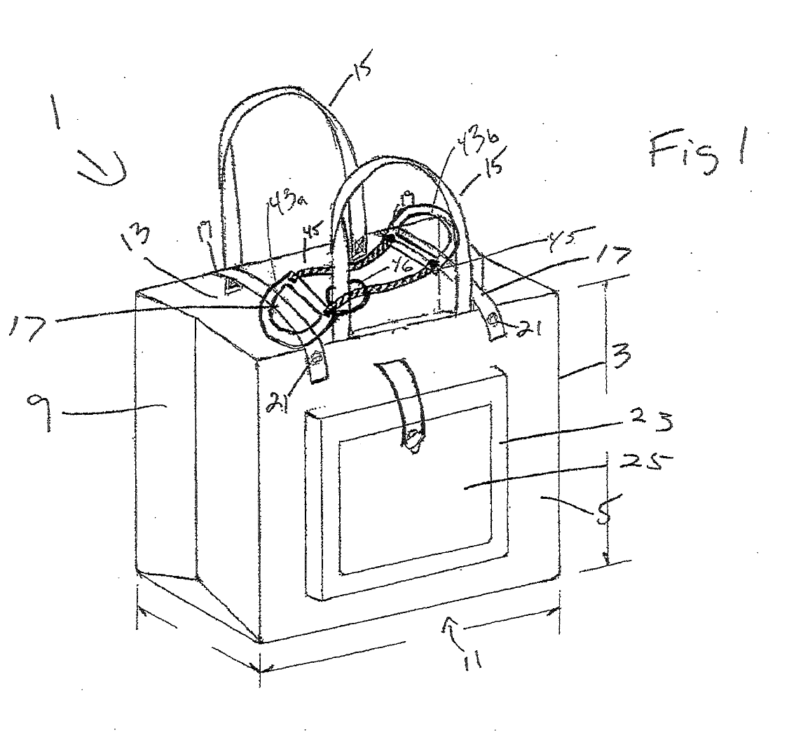

Referring to FIGS. 1-3, the shopping bag or carryall 1 contains a main body 3. The main body 3 is shaped like a conventional bag with a front wall 5, a back wall 7, side walls 9 and a bottom wall 11. Together the walls form shopping bag 1 with an opening 13 at the top. A preferred main body 3 shape is illustrated; however, as will be apparent to those skilled in the art, the main body 3 can have various shapes and sizes depending on the intended use of the end product. One skilled in the art can design any number of main body configuration according to the invention bearing in mind the limitations and advantages of the materials used and the intended use. For example a larger main body can be used if the intended use is a beach bag or gym bag.

The bag 1 can be constructed out of a variety of materials that are known in the industry. Preferably the bag 1 is constructed of a canvas type of material but numerous other types of material can be used. Generally, the choice of material only requires that it have sufficient strength to meet the objectives of the invention. The bag 1 is preferably sized to hold the contents of a conventional grocery shopping bag.

A pair of elongated handles 15 is positioned on the top of both the front wall 5 and back wall 7. These are used to carry the shopping bag 1. The handles 15 can be shorter or longer as is required and may have an adjustable length.

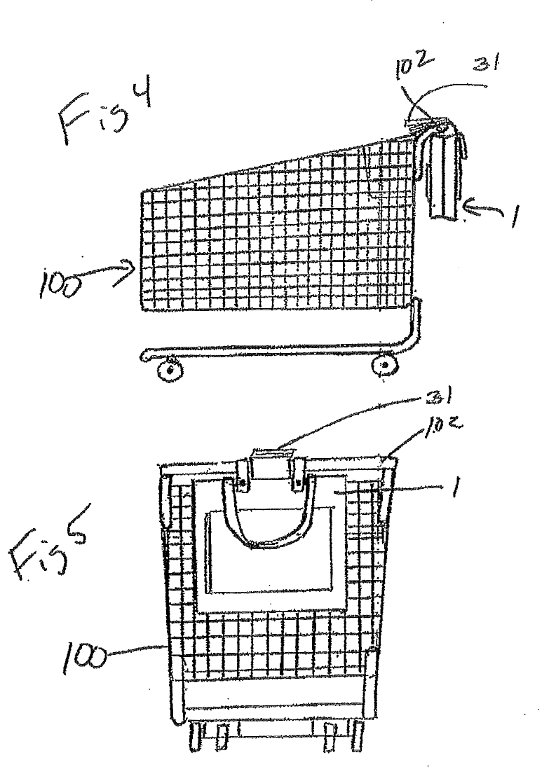

The shopping bag has one or more optional features attached to the main body 3. In addition to the elongated handles 15, shopping cart handle straps 17 are attached at or near the top of main body 3 and extend across the opening 13 of the bag 1. Two handle straps 17 are shown but more can be included to provide additional support so that the bag 1 can be secured to a shopping cart handle. As illustrated in FIGS. 4 and 5, the bag 1 is attached to the handle of a shopping cart 100 so that the bag hangs directly underneath the handle 102 of the shopping cart 100. The bag 1 is easily accessible to the shopper but is not in the interior of the cart 1.

The straps 17 are preferably permanently secured at one end 19 (either the front wall 5 or back wall 7) and have a means to releasably secure the second end 21 to the opposite wall. Alternatively, both ends of the handle straps 17 can be releasably secured to the main body 3. The means for releasably securing the straps 17 to the main body is preferably with snap fasteners but any number of devices can be used. For example, hook and loop type of fasteners can be used.

The front wall 5 has a large front pocket 23 on the outside of the bag 1. The large front pocket 23 optionally has one or more smaller pockets (not shown) on the interior of the large front pocket 23, either on the front interior or the back interior or both. These can be sized to hold or secure specific items such as, for example, a cell phone, wallet, keys, or glasses. The large front pocket 23 may optionally have a divider (not shown) on the interior of the pocket 23. In addition, the large front pocket may have a small front pocket 25 attached to the exterior of the large front pocket 23, for holding coupons, etc.

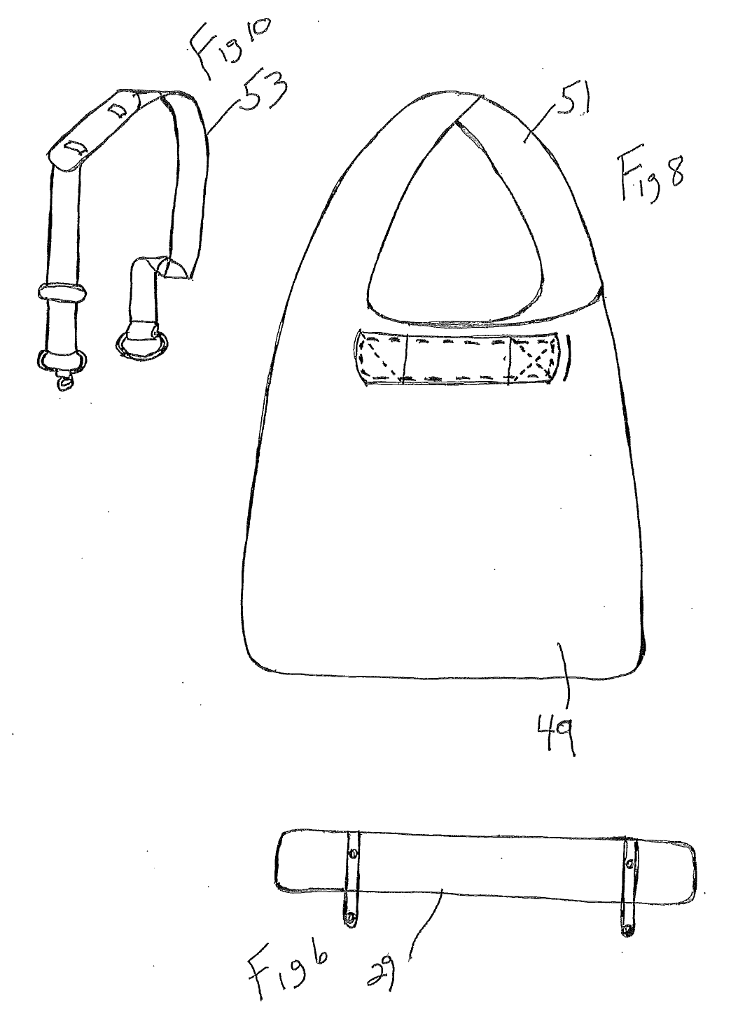

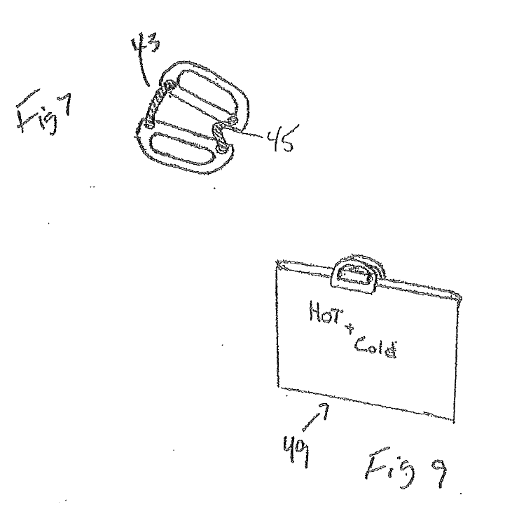

The back wall 7 has pouch 27 preferably constructed of netting but may be constructed of any material. The pouch 27 can hold a number of accessories including one or more shopping cart handle wraps 29, such as that shown in FIG. 6 and shoulder straps, such as that shown in FIG. 10. The handle wrap 29 can be made of any type of material but is preferably made of a machine washable fabric. The handle wrap 29 covers the shopping cart handle and can be secured to the handle by any number of securing means such for example as snaps, ties, and hook and loop.

The bag 1 has a transparent pouch or pocket 31 secured to the top of the bag 1 at the back wall 7 or front wall 5. The transparent pouch 31, preferably, is made of the same material or fabric as the bag 1 and has a clear plastic window 34. The pouch 31 is secured to the bag 1 in a way that it can be flipped upward to rest on the handle of a shopping cart when the bag 1 is a secured to a shopping cart by the shopping cart handle straps 17. The pouch contains a removable white board 33 or memo pad and pen, with magnetic backing (not shown). The white board 33 fits within the transparent pouch 31 so that when the pouch 31 is flipped up, the white board 33 can be seen through the clear plastic window. Alternatively, the transparent pouch 31 is a flap and a white board 33 is permanently attached to the underside of the flap. A pen 35 is provided for writing on the white board 33 or memo pad.

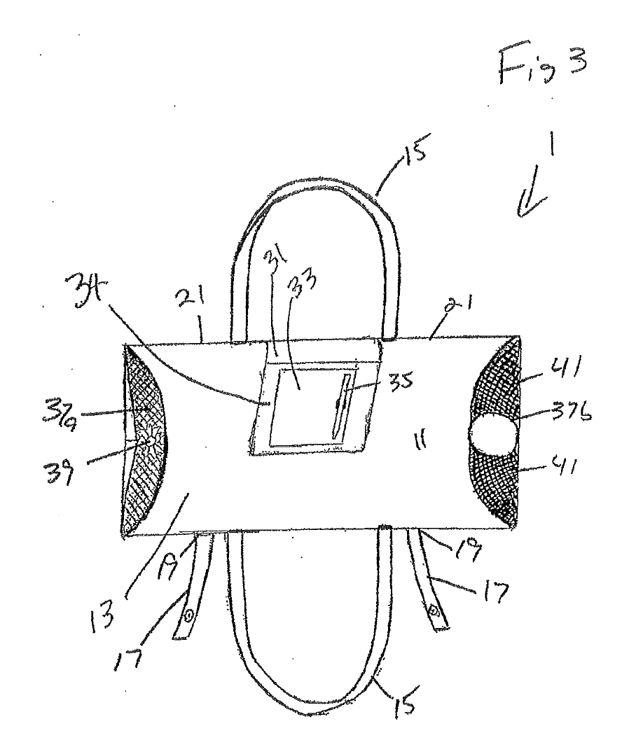

The main body 3 contains interior pockets 37 as best illustrated in FIG. 3. One interior pocket 37a is sized to hold a small umbrella 39 and is positioned on a side wall 9a. A second interior pocket 37b on the other side wall 9b is sized to receive a water bottle or baby bottle 41. One or both of the interior pockets 37 are preferably constructed on elastic netting or other elastic material in order to tightly secure the contents of the pocket and prevent spilling of the bottles 41.

The main body 3 has a pair of handle grips 43a and 43b attached to each other by way of one or more cords 45 or short lengths of rope. Two cords 45 are shown for each pair of grips 43 but more or less can be used. The handle grips 43 are permanently secured to one of the elongated handles 15. Preferably the pair of handle grips 43 is slidably connected to a handle via a plastic, metal or cloth ring 46 or by any number of means known in the art. The ring 46 freely slides along the length of the handle 15 so the pair of grips will rest in the bag 1 when not in use.

When the grips 43 are extended away from the bag 1, additional full grocery bags can be secured to the exterior of the main body 3, one additional bag on the front side 5 and one additional bag on the back side 7. The main body 3 of the bag can also hold a grocery bag or groceries. In this way, three, or possibly more, full grocery bags can easily be carried by the shopping bag 1 of the invention. An extra set of grips 43 (such as that shown in FIG. 6) that are not attached to the bag 1 can be used to carry up to three more grocery bags. These grips are optionally included as an accessory to the bag.

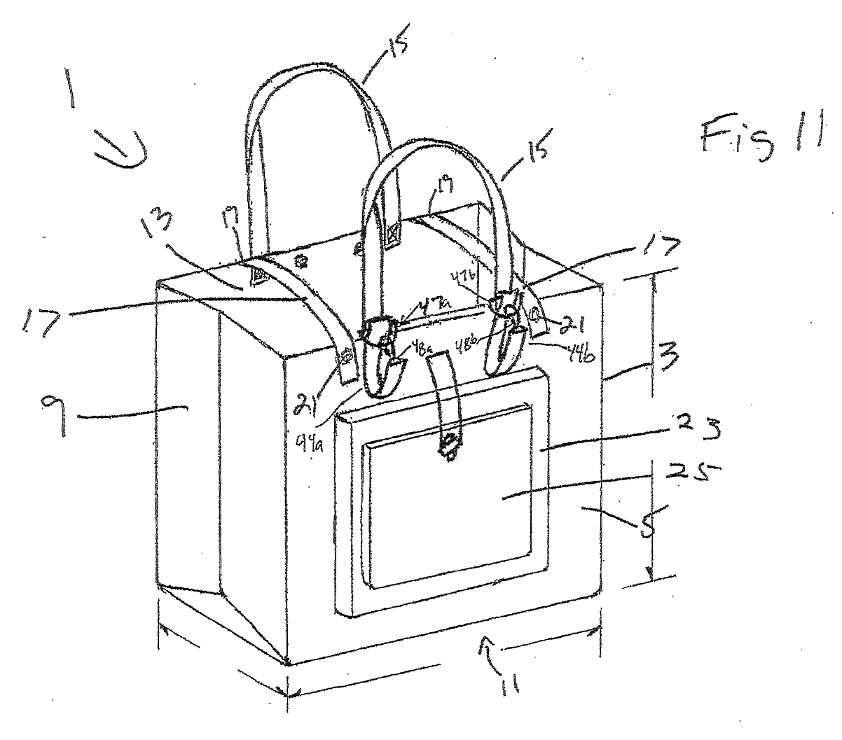

In the preferred embodiment, the grocery bags are reusable bags 49 as shown in FIG. 8. The reusable bags 49 have one or more handles 51 that can be attached to the handle grips 43 or loops created by bands 44 (discussed below). The bags 49 are preferably constructed of machine washable material and can be conveniently carried in the main body 3 or one or more of the pockets of the bag 1 and are included as optional accessories. The reusable bags 49 can be folded to a small size and conveniently stored in the bag 1. Alternatively, one or more of the reusable bags 49 may be an insulated bag for keeping hot and cold items at the right temperature, such as illustrated in FIG. 9.

Referring to FIG. 10, one or more shoulder straps 53 are optionally permanently or detachably secured to the top or side of the main body of the bag 1, or the interior of the bag by way of the interior rings as discussed above. The shoulder straps 53 allow the shopper to carry the shopping bag and grocery bag hands free and can assist when multiple bags 49 are attached to the grips 43 or bands 44.

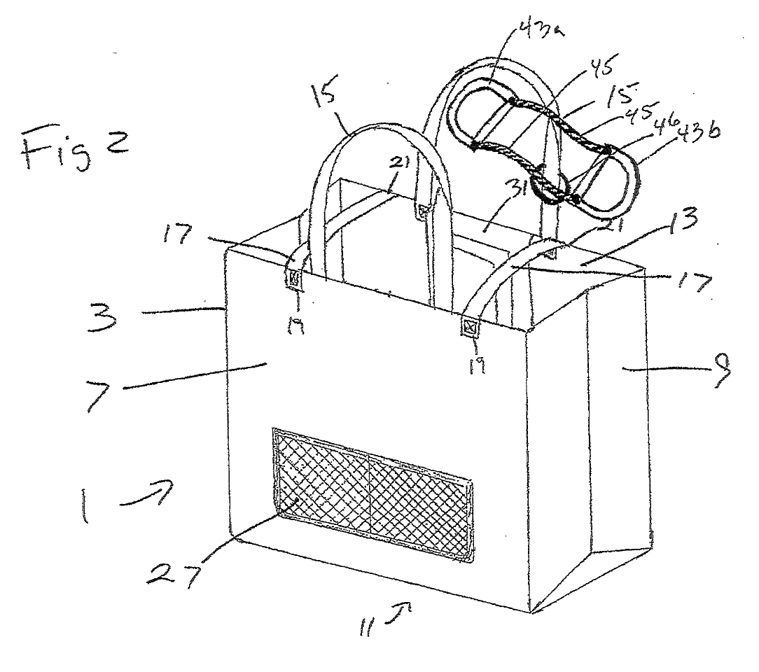

FIG. 11 illustrates an alternate embodiment of the bag 1. Similar to the embodiment in FIGS. 1 and 2, the bag has a main body 3, a pair of elongated handles 15 and one or more optional features attached as described above. Instead of the grips 43, the bag 1 has a pair of bands, belt or ties 44a and 44b permanently secured to the main body 3 (in this instance the front wall 5) at one end of each band 44a and 44b. Each band 44a and 44b is preferably adjustable in length and has a means to releasably attach or secure the free end of the band 44a and 44b to the permanently secured end. The means to releasably secure the free end to the permanently secured end can be any device or method typically used in the art, including but not limited to snaps, clips, rings, or Velcro® or other hook and loop type fasteners. In the embodiment shown, a metal or plastic ring 47a and 47b is attached at the permanently secured end. A fastener such as a metal or plastic carabiner (metal loop with a sprung or screwed gate) 48a and 48b is attached the free end. Alternate fastening means can be utilized. The two ends of the band 44 can be quickly attached and unattached to form a loop for securing additional bags (such as reusable bags 49) to the main bag 1. Two bands 44 are shown but more or less can be used.

This configuration allows additional full grocery bags or other items to be secured to the exterior of the main body 3 within the loop of the bands 44a and 44b. The back wall 7 of the bag 1 may also have bands. The main body 3 of the bag can also hold a grocery bag or groceries. In this way, three or more, full grocery bags can easily be carried by the shopping bag 1 of the invention.

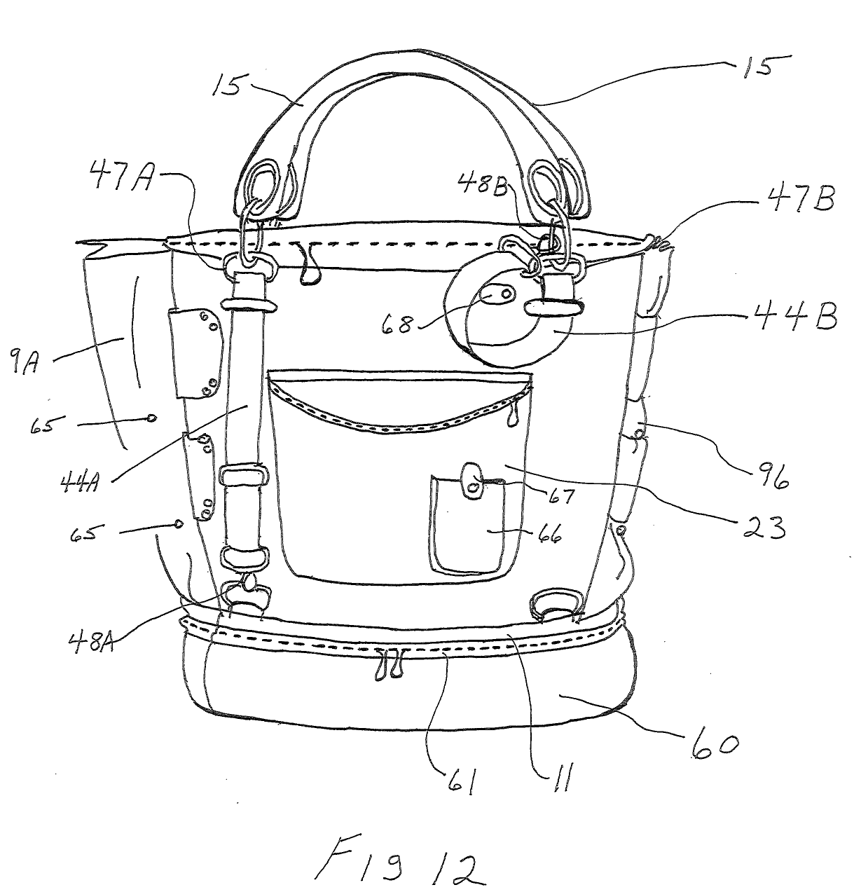

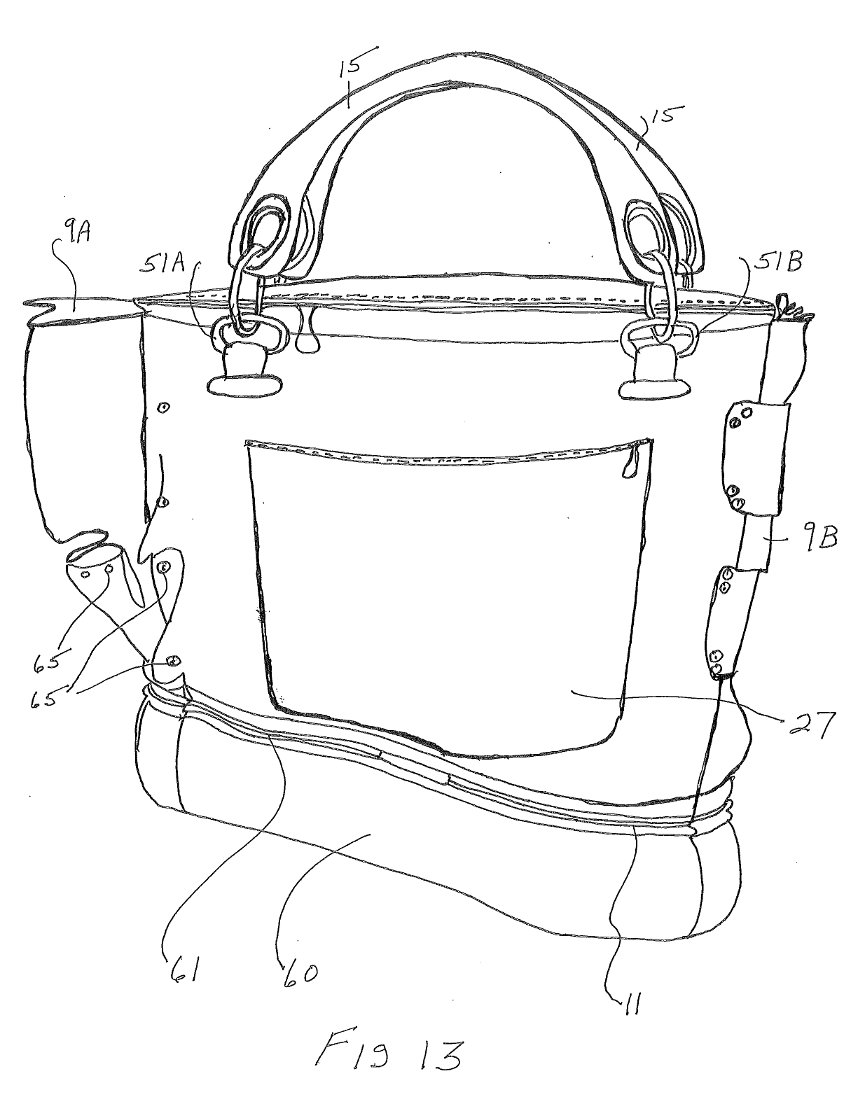

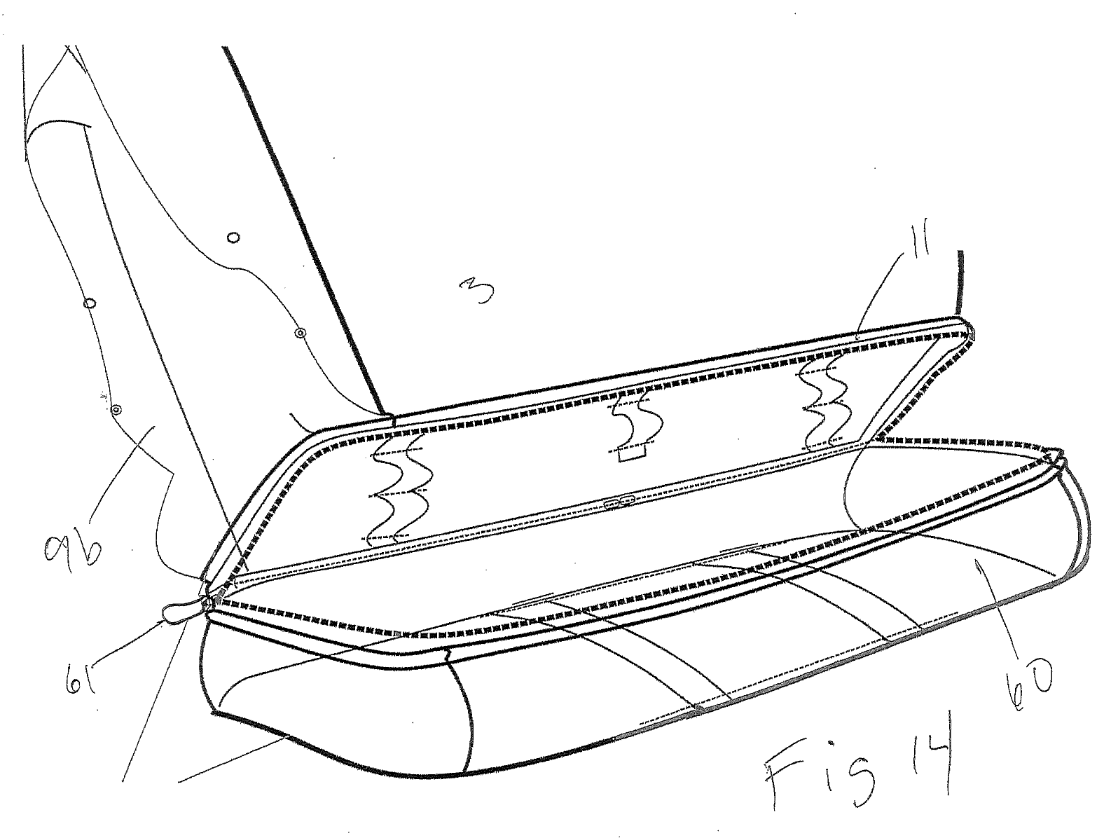

FIGS. 12 and 13 illustrate an alternate embodiment of the bag 1. Similar to the embodiment in FIGS. 1 and 2, and FIG. 11, the bag has a main body 3, a pair of elongated handles 15 and one or more optional features attached as described above. As in FIG. 12, the bag 1 has a pair of bands, belt or ties 44a and 44b permanently secured to the main body 3 (in this instance the front wall 5) at one end of each band 44a and 44b. Each band 44a and 44b is preferably adjustable in length and has a means to releasably attach or secure the free end of the band 44a and 44b to the permanently secured end to form loop (shown as 44b) for securing additional bags (such as reusable bag 49 for example) to the bag 1. The free ends of the bands 44a and 44b can also be secured to loops 51a and 51b on the back wall 7 of the bag 1 in order to form shopping cart handle straps 17 as described above. Finally, the bands 44a and 44b can be attached toward the bottom of the side to which is attached (shown as 44a) so that the free end is not loose.

The means to releasably secure the free end to the permanently secured end can be any device or method typically used in the art, including but not limited to snaps, clips, rings, or Velcro® or other hook and loop type fasteners. In the embodiment shown, a metal or plastic ring 47a and 47b is attached at the permanently secured end. A fastener such as a metal or plastic carabiner (metal loop with a sprung or screwed gate) 48a and 48b is attached the free end. Alternate fastening means can be utilized. The two ends of the band 44 can be quickly attached and unattached to form a loop for securing additional bags to the main bag or to form shopping cart handle straps 17 (not shown in this embodiment). Two bands 44 are shown but more or less can be used.

Alternatively, the bands 44, when the free ends are attached or secured to a point toward the bottom wall 11, can function as backpack straps or shoulder straps. The bands 44 are preferably adjustable in length and can optionally be fitted with padding as in a traditional backpack.

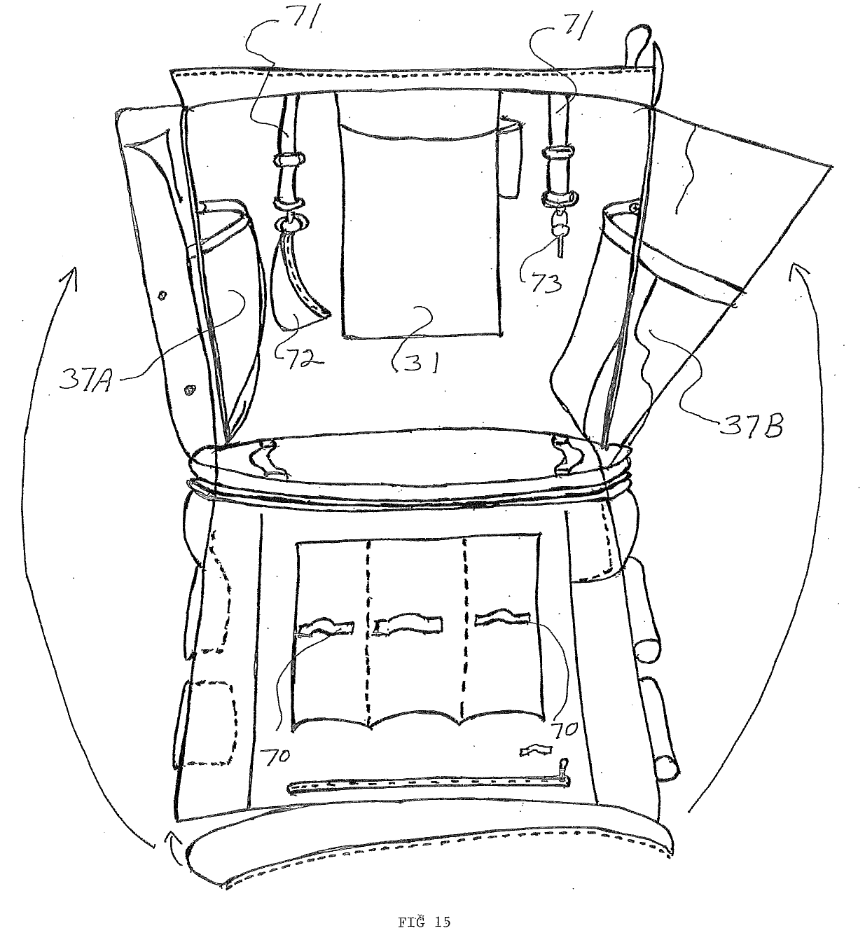

An optional feature in this embodiment, best illustrated in FIG. 14, is an additional bottom compartment 60. The bottom compartment 60 is attached to the bottom wall 11 of the main body 3 of the bag 1. In the embodiment shown the bottom compartment is secured and opened by way of a zipper 61, but other methods of attachment and closure, such as snaps, may be used. The compartment 60 can be of various sizes but is preferably large enough to store a pair of shoes or sneakers for example, or other items. The compartment 60 can be made of the same material as the main body of the bag or different material. In one embodiment, the compartment 60 is made of a more rigid material such that it maintains its shape. In another embodiment, the bottom of the compartment 60 is substantially flat and rigid so that the bag 1 can be placed on the floor or other flat surface without falling to one side.

Various additional optional features are included. The bag includes one or both expandable sides in which the volume and capacity of the inside of the bag 1 can be increased or decreased. FIGS. 12 and 13 illustrate one means for expanding and contracting the width of the side walls 9 utilizing appropriately positioned snaps 65 to either expand the side wall (as shown in side wall 9a) or contract the side wall (as shown in side wall 9b). Alternatively, the volume of the bag can be increased by including a collapsible and expandable bottom or sides to increase or decrease the height of the bag.

The front pocket 23 on the outside of the bag contains a zipper for opening and closing the pocket. Additionally the front pocket contains a pouch or pocket 66 with fastening means 67 for such items as a cell phone or similar electronic device. Optionally the body 3 of the bag contains an attachment 68 for an ear pierce.

The interior of the bag may contain the feature as discussed above. In addition or alternately, other features in the interior of the bag 1 may include, as shown in FIG. 15, one or more of the following: one or more elastic or stretchable bands 70 to secure miscellaneous items; straps with clips 71 or other attachment means for attaching such items as a change purse 72, keys 73 or other personal items. In addition, the interior of the bag may contain rings to attach an additional shoulder strap as discussed below, or pouches for storing the reusable shopping bags as discussed further below.

There will be various modifications, adjustments, and applications of the disclosed invention that will be apparent to those of skill in the art, and the present application is intended to cover such embodiments. Accordingly, while the present invention has been described in the context of certain preferred embodiments, it is intended that the full scope of these be measured by reference to the scope of the following claims.

What is claimed is:

1. A bag comprising:
a main body;
handles attached on either side of the main body;
shopping cart handle straps attached to one side of the main body that can be releasably secured to the opposite side of the main body;
means attached on either side of the main body or handles for securing additional bags to the main body of the bag.

2. The bag of claim 1 further comprising a shoulder strap releasably attached to the main body wherein the shoulder strap is longer than the handles.

3. The bag of claim 1 wherein the means of securing additional bags to the main body of the bag comprises one or more or bands attached to either side of the main body, wherein the bands have means for releasably forming a loop.

4. The bag of claim 2 wherein the one or more bands comprise an attached end with a metal or plastic ring at the attached end and a free end with a fastener on the free end.

5. The shopping bag of claim 1 further comprising a rear pocket.

6. The shopping bag of claim 1 further comprising one or more pockets on the interior of the main body constructed of an elastic material.

7. The shopping bag of claim 1 further comprising a bottom compartment connected to the bottom of the main body of the shopping bag.

8. A shopping bag comprising
a main body;
handles attached on either side of the main body;
shopping cart handle straps attached to one side of the main body that can be releasably secured to the opposite side of the main body, wherein the straps are of shorter length than the handles attached to the main body;
one or more extendable handle grips attached to either side of the main body, wherein the handle grips have means for attaching additional bags to the handle grips;

9. The shopping bag of claim 8 further comprising sanitary handle wraps sized to be removably secured to a shopping cart handle and wherein the shopping bag comprises a pocket for storing the shopping cart handle.

10. The shopping bag of claim 8 further comprising a shoulder strap that releasably attaches to the shopping cart bag.

11. The shopping bag of claim 8 further comprising additional handle grips for carrying additional shopping bags.

12. The shopping bag of claim 8 wherein one or more of the reusable shopping bag is an insulated hot and cold bag.

13. The shopping bag of claim 8 wherein the shopping bag further comprising a clear plastic pocket attached to the main body of the bag wherein the pocket rotates or flips up from the interior of the bag and can rest on the shopping cart handle when the bag is secured to a shopping cart.

14. The shopping bag of claim 8 wherein the shopping bag further comprising a pouch on the front of the main body and small pocket on the outside of the front pocket.

15. The shopping bag of claim 8 wherein the shopping bag further comprising a rear pocket.

16. The shopping bag of claim 8 wherein the shopping bag further comprising one or more pockets on the interior of the main body constructed of an elastic material.

17. The shopping bag of claim 1 further comprising a bottom compartment connected to the bottom of the main body of the shopping bag.

18. A shopping bag kit comprising:
a primary shopping bag; and
one or more reusable shopping bags,
wherein the primary shopping bag comprises a main body;
handles attached on either side of the main body;
shopping cart handle straps attached to one side of the main body that can be releasably secured to the opposite side of the main body;
means attached on either side of the main body or handles for securing the one or more reusable shopping bags to the main body of the bag.

19. The shopping bag kit of claim 18 wherein the means attached on either side of the main body or handles for securing additional bags to the main body of the bag comprise two or more bands attached to the main body, wherein the bands can releasably form into loops.
